(19) United States
(12) Patent Application Publication
(10) Pub. No.: US 2026/0341616 A1
(43) Pub. Date: Oct. 29, 2026

(54) SWITCHING DEVICE

(71) Applicant: Siemens Aktiengesellschaft, München (DE)

(72) Inventors: Dominic Malane, Eichstätt (DE); Thomas List, Sulzbach-Rosenberg (DE); Stefan Langen, Kastl (DE); Hauke Nannen, Nürnberg (DE)

(21) Appl. No.: 19/102,491

(22) PCT Filed: May 17, 2023
(86) PCT No.: PCT/EP2023/063227

§ 371 Date: Feb. 10, 2025

(30) Foreign Application Priority Data
Aug. 10, 2022 (DE) 10 2022 208 317.2

(51) Int. Cl. H01H 47/00; H02H 1/00; H02H 3/00

(52) U.S. Cl. CPC H01H 47/002; H02H 1/00; H02H 3/00

(57) ABSTRACT

A switching device contains two or more current paths via which energy can be supplied for a downstream load. An electronic interruption unit and a mechanical switch are arranged in series in each of the current paths. Each of the current paths has an assigned decentralized control unit, which is configured to actuate the electronic interruption unit.

The present invention relates to a switching device having two or more current paths which can be used to supply energy for a downstream electrical load, wherein an electronic interruption unit and a mechanical switch are arranged in series in each of the current paths. The present invention also relates to an operating method for the switching device. Switching devices for switching an energy supply for a downstream electrical load are known. For example, motor starters are used directly on the grid for driving and protecting three-phase motors. A distinction is made between direct starters and soft starters. Direct starters switch a grid voltage directly to the motor, whereas soft starters have the possibility of limiting or slowly increasing the effective voltage at the motor for the start-up time by means of phase gating, see the two graphs on page 21C-6 in: Siemens AG, Grundlagen der Niederspannungs-Schalttechnik [Principles of low-voltage switching technology], 2008, http://www.siemens.de/lowvoltage/grundlagen.

As a rule, the present-day motor starters are realized either by a corresponding interconnection of contactors, see DE 10 2008 026 376 A1 (Siemens AG) 12.02.2009, or are designed as a hybrid starter, see DE 10 2012 214 814 A1 (Siemens AG) 02.27.2014, where “hybrid” is used to mean a combination of robust relay technology and wear-free semiconductor technology. In both embodiments, a central control unit drives switching elements of the motor starter to assume either a current-conducting or a current-blocking state. For this purpose, the central control unit receives, from sensors which monitor current paths leading through the motor starter, measured values relating to current, voltage or temperature, from which the central control unit can derive whether acceptable operating conditions prevail in the current paths, such that electrical energy can be conducted through the current paths and the switching elements to the motor, or whether unacceptable operating conditions such as a short circuit or a longer-lasting overload are present, such that the current conduction through the current paths has to be interrupted by means of the switching elements.

The object of the present invention is an improved switching device. This object is achieved according to the invention by means of a switching device having the features specified in claim 1. This object is also achieved according to the invention by means of a method having the features specified in claim 9.

The switching device has two or more current paths which can be used to supply energy for a downstream load. The switching device can be, for example, a motor starter, a soft starter or a contactor. The load may have an inductive behavior, e.g. an electric motor, a resistive behavior, e.g. an electric heater, or a capacitive behavior, e.g. a rectifier. The current paths conduct the load current provided for the electrical load from a grid-side connection apparatus of the switching device through the switching device to a load-side connection apparatus of the switching device. An electronic interruption unit and a mechanical switch are arranged in series in each of the current paths, i.e. the current for supplying the load is conducted both via the electronic interruption unit and via the mechanical switch. Preferably, the electronic interruption unit is assigned to the grid-side connection apparatus and the mechanical switch is assigned to the load-side connection apparatus.

An electronic interruption unit is an electronic switch that realizes the function of an electromechanical switch, but that does not have any moving parts. The electronic interruption unit can be switched by semiconductor-based switching elements into a high-impedance state of the switching elements for avoiding a current flow or a low-impedance state of the switching elements for current flow in the current path; to this end, semiconductor-based switching elements such as field effect transistors (FET), MOSFETs (silicon, gallium nitride, silicon carbide), IGBTs, bipolar transistors or diodes are used. An electronic interruption unit has, in addition to a semiconductor switch, a protection element for the semiconductor switch.

A mechanical switch, also referred to as a mechanical isolating contact unit, is an electromechanical switch which can be switched into a current-blocking state by opening contacts in order to avoid a current flow in the current path or into a current-conducting state by closing the contacts for a current flow in the current path. The mechanical switch is a mechanical isolating contact system, in particular having isolator properties according to relevant standards for low-voltage circuits (voltages of up to 1000 volts AC or up to 1500 volts DC), wherein the contacts of the mechanical isolating contact system are connected in series with the electronic interruption unit. The mechanical switch can be designed, for example, as a relay.

The current paths are each assigned a decentralized control unit which is designed to drive the electronic interruption unit; the switching state of an electronic interruption unit (current-conducting or current-blocking) is thus controlled by the assigned decentralized control unit. The switching device according to the invention can be connected into an electrical supply line of an electrical load and can be used to switch and/or protect the electrical load; therefore, the switching device according to the invention can alternatively also be referred to as a switching and protection device. Protecting the electrical load by means of the switching device serves to protect the electrical load and the supply line leading to the electrical load from impermissibly high currents. A supply line of an electrical load is an electrical line which is used to supply the load with electrical energy. Examples of the use of a switching device are applications as circuit breakers, contactors, relays and motor starters, i.e. a switching device for starting an electric motor.

The method according to the invention serves for operating a switching device having two or more current paths which are used to supply energy for a downstream load. In this case, an electronic interruption unit and a mechanical switch are arranged in series in each of the current paths. The method comprises driving the electronic interruption unit of a current path in each case by means of a decentralized control unit assigned to this current path.

The invention is based on the finding that a multi-controller architecture for an electronic switching and protection device, i.e. a switching and protection device equipped with electronic interruption units, offers advantages in short-circuit protection: Since the current and/or voltage values from which the short circuit is detected need not first be sent via a long transmission path to a central control unit and the switching commands need not be sent back from there to the electronic interruption unit again, but rather the current and/or voltage values are analyzed and the switching commands are generated in a decentralized control unit which is arranged physically close to the current/voltage sensor and the electronic interruption unit and can be reached via short transmission paths, a switching reaction to an incoming risk such as a short circuit or overload can take place significantly faster than before.

By distributing the control function among a plurality of decentralized control units, smaller and more cost-effective control units can be used than in an architecture with a single central control unit. By virtue of a skillful division of the functions between the central control unit and the decentralized control units, it is also possible to use less powerful controllers in comparison with a single controller solution.

If a decentralized control unit fails, the central control unit takes over the driving of the electronic interruption unit assigned to the failed decentralized control unit. If the decentralized control unit detects failure of a sensor, the decentralized control unit sends a switch-off command directly to the assigned electronic interruption unit, so that the unsafe operating state is ended as quickly as possible. In addition, the decentralized control unit reports this information that there is a fault in a sensor to the central control unit which then triggers actions of the other decentralized control units.

This implementation of a switching device with a decentralized control unit for each current path can be referred to as a “multi-controller” architecture; such an architecture is the core of the present invention. It serves as a basis for a modular construction both on the part of HW development and on the part of FW development (FW=firmware, HW=hardware). It can be used, for example, for a 3-phase motor starter or for a (3+N) infrastructure switch. The invention provides a switching device which offers short-circuit strength for very high grid connection powers, offers short-circuit protection even for very high current rises and is flexible with regard to the expansion of protection and measurement functions. In particular, the decentralized control units enable flexibly adjustable short-circuit limits for each phase or each current path.

Advantageous configurations and developments of the invention are specified in the dependent claims.

According to one preferred configuration of the invention, the switching device has a central control unit which is designed to communicate with the decentralized control units for coordination of the electronic interruption units and the mechanical switches in the two or more current paths. An advantage here is that the central control unit receives information relating to measured values in the current paths and switching states of the electronic interruption units from the decentralized control units and, on the basis of this information, can possibly send additional switch-on or switch-off commands to the decentralized control units.

According to one preferred configuration of the invention, the central control unit is designed as a separate physical electronic component of the switching device. An advantage here is that the firmware running in the decentralized control units can be identical and thus different runtimes for executing algorithms of the firmware are unlikely.

According to one preferred configuration of the invention, the central control unit is integrated in the form of a firmware block (firmware stack) in at least one of the decentralized control units. The FW block offers the full functionality of the central control unit for coordinating the phases, i.e. for coordinating the electronic interruption units and the mechanical switches in the two or more current paths of the switching device. An advantage here is that hardware is saved, namely a separate physical electronic component for a central control unit.

The central control unit is provided as a separate controller or as an FW block running on one of the decentralized control units. This central control unit then receives all information relating to measurement variables and state in the corresponding other current paths and can then possibly send switch-on or switch-off commands to the other decentralized control units.

The central control unit sends information, e.g. switching commands, parameter sets, commands for activating additional functions, to the decentralized control units and receives information, e.g. measured values, fault states, parameter sets, from the decentralized control units. The central control unit can be designed to activate the voltage supply of the decentralized control units.

According to one preferred configuration of the invention, the current paths are each assigned a sensor for measuring a current intensity in the current path and/or a voltage in the current path against a reference voltage of another current path, wherein the sensor is designed such that the measured values can be transmitted to the decentralized control unit assigned to the current path. To this end, the sensor can have an interface for wired or wireless transmission. An advantage here is that the current operating conditions in the current paths and the state of the energy supply for a downstream load can be detected.

According to one preferred configuration of the invention, the switching device has an interface for parameterizing the switching device. An advantage here is that the switching device can be parameterized simply by means of an external parameterization device in a wired or wireless manner.

According to one preferred configuration of the invention, provision is made for the decentralized control units to communicate directly with one another. In other words, the decentralized control units are designed to communicate with one another. For example, two digital signals (input and output) may be exchanged, i.e. sent and received, between two decentralized control units. For example, the information relating to a current zero crossing in a decentralized control unit can be transmitted to one or more of the other decentralized control units. The direct communication can take place in various ways.

A first possibility is data communication via a bus system, for example using an SPI (=Serial Peripheral Interface) or a serial interface, for example UART (=Universal Asynchronous Receiver Transmitter), for exchanging information such as measurement variables and states of the decentralized control units with one another, in the form of binary character strings, without involving the central control unit. For example, this information exchange is necessary when implementing the central control functions in the decentralized control units in the form of the FW block.

In the case of the second possibility, only digital individual signals with a rising edge, a falling edge and a duration of the signal level are transmitted as information carriers. In the case of these digital signals which are generated by the decentralized control units, information can be encoded in the rising edge, the falling edge and the duration of the signal level. Which information, for example overcurrent fault, overload fault, current zero crossing, is assigned to the respective signal can be stipulated in advance by the central control unit in a coding rule which is made available to the decentralized control units. Zero current detection in one of the decentralized control units could be mentioned here as an example. If a current zero crossing is detected, the level of a digital signal is changed from low to high, or else high to low. This signal is captured by the other decentralized control units and actions can accordingly be triggered by the decentralized control units. The information relating to the zero crossing in a decentralized control unit may be relevant to the other decentralized control units. The transmission system for transmitting digital signals via digital signal lines between the decentralized control units avoids delays which can occur in a bus system on the basis of the communication medium and the processing of the information.

According to one preferred configuration of the invention, an insulation barrier is formed between two current paths in each case. An advantage here is that the electrical safety is improved.

According to one preferred configuration of the invention, the decentralized control units each have configurable analogueue modules. The analogueue modules may be, for example, comparators or operational amplifiers. These analogueue modules integrated in the decentralized control units may be configurable by firmware, which may reduce the complexity of externally required hardware. An advantage of this configuration of the invention is that high flexibility is ensured and the production and repair of the switching device are simplified.

According to one preferred configuration of the invention, the decentralized control unit, the electronic interruption unit and the sensor, which are each assigned to a current path, form a protection and measurement module. Such a module can also be referred to as a protection and measurement cell. In addition to short-circuit protection, a module of this type can also assume further functions:
Shunt-based current measurement with a very high bandwidth of >500 kHz: For this purpose, the module can have a shunt for measuring the current in the current path. As a result, the switching device can detect a short circuit relatively quickly and react thereto.
Measuring the grid voltage between two current paths and measuring the switch voltage applied across the electronic interruption unit: For this purpose, the module can have one or more voltage measuring devices for measuring voltages. As a result, a short circuit can be detected. From the variables of grid voltage and switch voltage, the central control unit can infer the voltage present on the load side at the control device; this information can be used, for example, when restarting an electric motor.
Providing the measured values via a communication interface of the module. For this purpose, the module can have a communication interface. The measured values can be made available to the central control unit via this communication interface.

The core of the protection and measurement module is the decentralized control unit, i.e. a controller which can implement protection and additional functions. The protection and measurement modules or the decentralized control units of a switching device are coordinated by a superordinate controller, the central control unit. Via communication connections and interfaces, the central control unit can trigger actions of a decentralized control unit, for example connecting a power semiconductor, performing diagnostic functions, etc. Furthermore, measured values or states can be transmitted from the decentralized control units to the central control unit via communication connections and interfaces.

According to one preferred configuration of the invention, the method has the following steps: measuring a current intensity and/or a voltage in the current path; sending the measured values to the decentralized control unit assigned to the current path; sending control commands to the electronic interruption unit of a current path on the basis of the measured values measured in the current path. An advantage here is that the current operating conditions in the current paths and the state of the energy supply for a downstream load can be detected.

According to one preferred configuration of the invention, the switching device has signal lines which can be used to synchronize the decentralized control units or the protection and measurement modules, for example for simultaneous sampling of measured values in all protection and measurement modules. For this purpose, the switching device can have signal lines specifically provided for this purpose, or synchronization signals required for synchronization are sent via the communication connections, which are present in any case, between the central control unit and the decentralized control units.

According to one preferred configuration of the invention, the central control unit sends synchronization signals to the decentralized control units, as a result of which the decentralized control units can be synchronized. By means of the synchronization signals received by the decentralized control units, the decentralized control units can synchronize their calculation steps and/or actions with one another, thus ensuring simultaneous execution of the calculation steps and/or actions. The accuracy of the synchronization of the decentralized control units can be in the range of nanoseconds. Calculation steps may relate to executing an algorithm running, for example, in the form of a computer program on a decentralized control unit. Actions comprise switching an electronic interruption unit at a switching time and scanning devices of the analogueue peripherals at a scanning time. A synchronization signal can be formed by a falling and/or rising edge of a digital signal.

According to one preferred configuration of the invention, the method has the following steps: sending information relating to the measured values and the control commands from the decentralized control units to a central control unit of the switching device; coordinating, by means of the central control unit, the electronic interruption units and the mechanical switches in the two or more current paths on the basis of the received information. An advantage here is that the central control unit receives all information relating to measurement variables and state in the corresponding other current paths and can possibly send switch-on or switch-off commands to the other decentralized control units.

The invention is explained below with reference to the accompanying drawing. In the drawing, schematically and not to scale in each case,

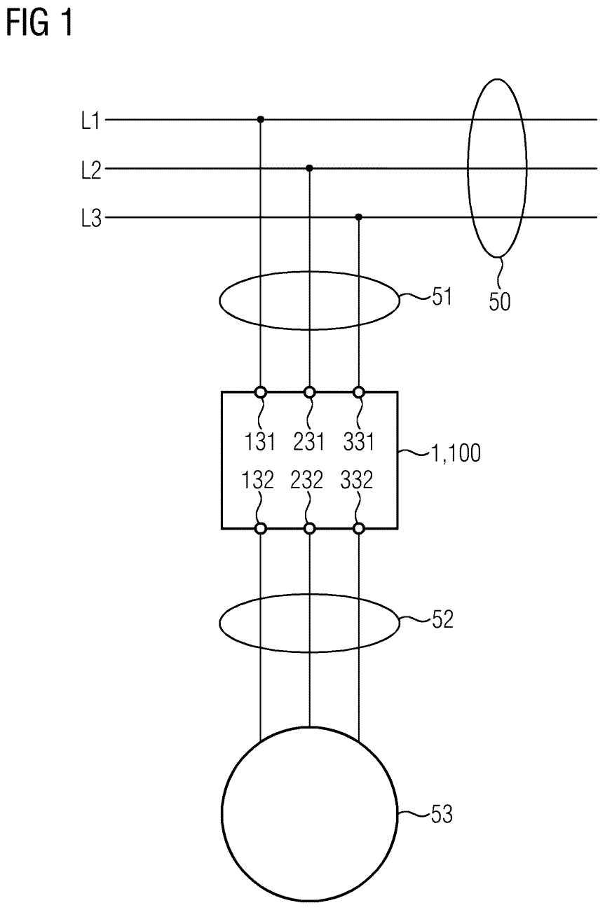

FIG. 1 shows a typical circuit arrangement of a switching device;

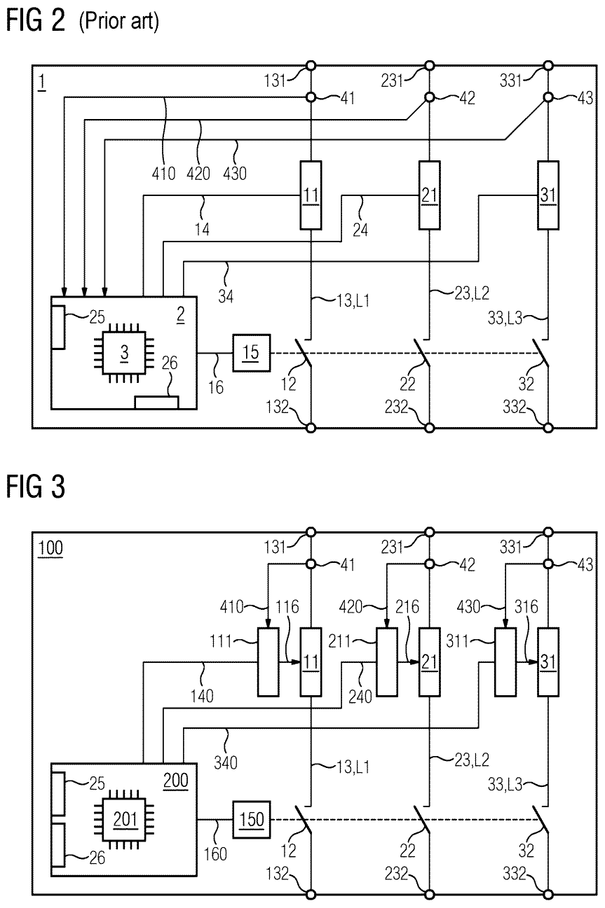

FIG. 2 shows a schematic construction of a known switching device;

FIG. 3 shows a schematic construction of a switching device according to the invention;

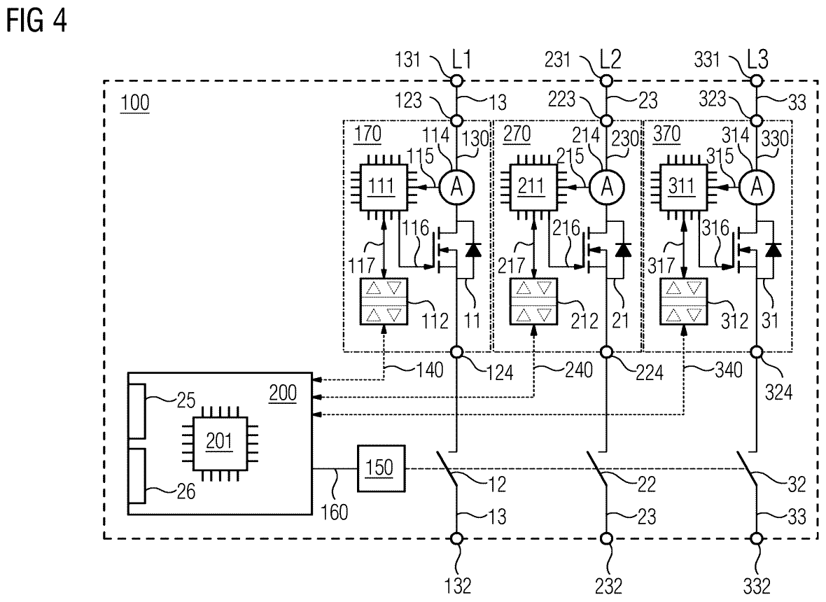

FIG. 4 shows a configuration of a switching device according to the invention;

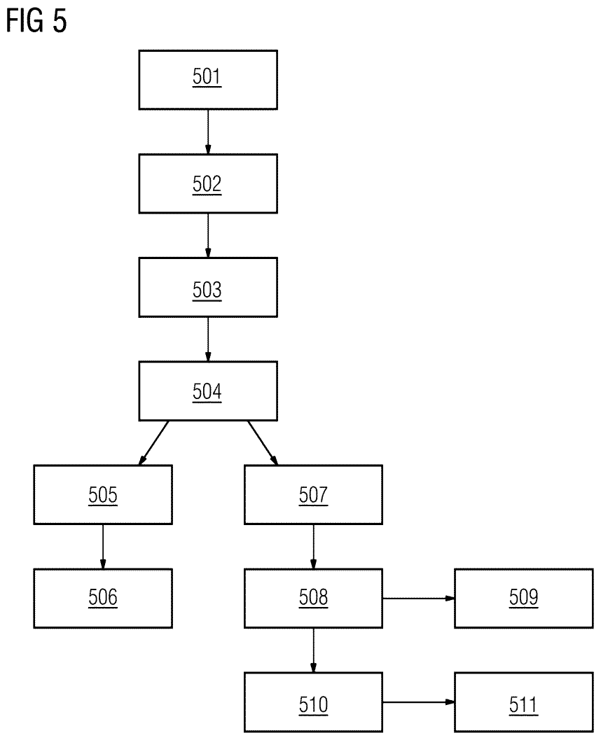

FIG. 5 shows a flowchart of a short-circuit disconnection;

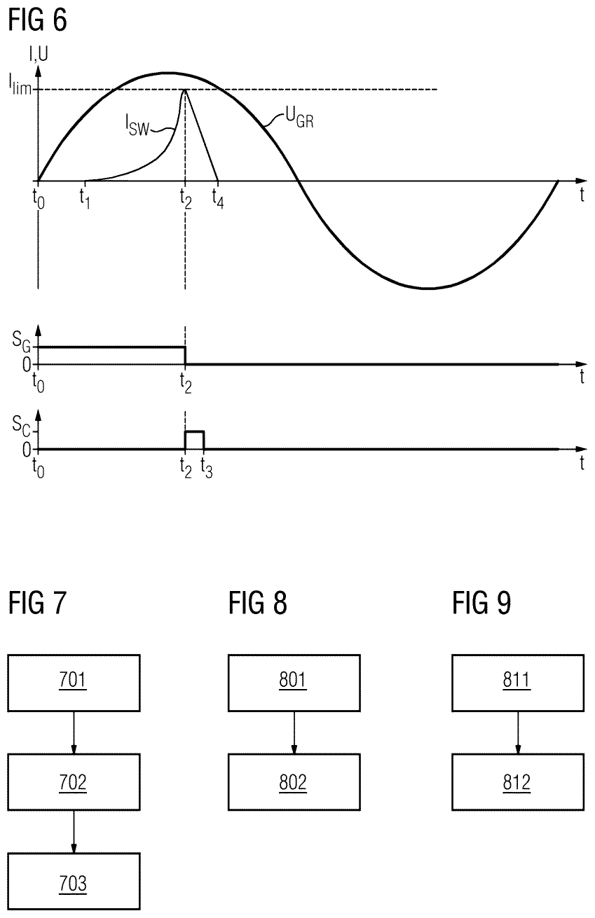

FIG. 6 shows an example of a short-circuit disconnection;

FIG. 7 shows a flowchart of an operational switch-on;

FIG. 8 shows a flowchart of a first mode of an operational switch-on; and

FIG. 9 shows a flowchart of another mode of an operational switch-on;

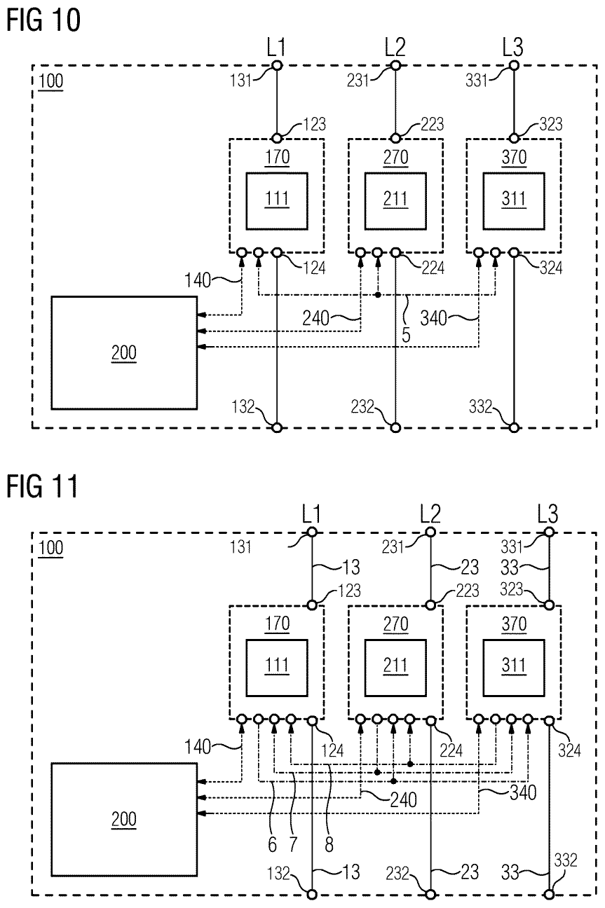

FIG. 10 shows a configuration of direct communication via a bus system; and

FIG. 11 shows a configuration of direct communication by means of digital signals.

FIG. 1 shows a typical circuit arrangement of a switching device 1 which is arranged in a three-phase electrical supply line 51, 52, divided into a grid-side supply line 51 and a load-side supply line 52, via which electrical energy is conducted from an electrical supply grid 50 having three outer conductors L1, L2, L3 to an electrical load 53, for example an electric motor or an electric heater. The switching device 1 has grid-side connection apparatuses 131, 231, 331 and load-side connection apparatuses 132, 232, 332 which are used to connect the switching device 1 into the electrical supply line 51, 52. FIG. 2 schematically shows the internal construction of a conventional switching device 1 which can be used in a circuit arrangement as illustrated in FIG. 1. The switching device 1 has three current paths 13, 23, 33, via which in each case one of the outer conductors L1, L2, L3 of the three-phase supply grid 50 can be routed. For this purpose, the switching device 1 has grid-side connection apparatuses 131, 231, 331, for example screw terminals or spring-loaded terminals, by means of which the grid-side ends of the current paths 13, 23, 33 can be electrically connected to the grid-side supply lines 51 of the supply grid 50. For this purpose, the switching device 1 also has load-side connection apparatuses 132, 232, 332, for example screw terminals or spring-loaded terminals, by means of which the load-side ends of the current paths 13, 23, 33 can be electrically connected to the load-side supply lines 52 of the load 53.

An electronic interruption unit 11, 21, 31 and a mechanical switch 12, 22, 32 are respectively arranged in series in each of the current paths 13, 23, 33, wherein an electrical current having a current direction from the grid-side connection apparatuses 131, 231, 331 to the load-side connection apparatuses 132, 232, 332 flows first through the electronic interruption units 11, 21, 31 and then through the mechanical switches 12, 22, 32. Current and/or voltage sensors 41, 42, 43, which are suitable for measuring the current I and/or the electrical voltage U in the current paths 13, 23, 33, are respectively arranged in the current paths 13, 23, 33 between the grid-side connection apparatuses 131, 231, 331 and the electronic interruption units 11, 21, 31.

The switching device 1 has a central control unit 2 which is equipped with a processor 3 and can receive measured values from the current and/or voltage sensors 41, 42, 43 via data lines 410, 420, 430 and can send switching commands via communication connections 14, 24, 34 to the electronic interruption units 11, 21, 31 and via a control line 16 to a switching lock 15 acting on the mechanical switches 12, 22, 32. The measured values from the current and/or voltage sensors 41, 42, 43 can be present as analogue signals or as digital data. Data lines 410, 420, 430 are understood here as meaning any transmission means, both transmission lines, for example cables, and wireless transmission means, for example NFC (=Near Field Communication), Bluetooth, WLAN (=Wireless Local Area Network).

The control unit 2 can analyze the received measured values from the current and/or voltage sensors 41, 42, 43 and can determine on the basis of the analysis whether the current and/or voltage values lie in a customary and correct range or in an unacceptable range, for example in an overload range, a short-circuit range, etc. The control unit 2 can respectively set a current-blocking state or a current-conducting state of the electronic interruption units 11, 21, 31 and the mechanical switches 12, 22, 32 by means of corresponding switching commands. In regular operation, the control unit 2 can switch a supply of electrical energy to the load by means of corresponding switching commands. For example, when interrupting a current path during regular operation, an undesired arc between the contacts of the mechanical switch can be avoided by first switching the electronic interruption unit to a current-blocking state and only then opening the mechanical switch. If current and/or voltage values lie in an unacceptable range, the switching device 1 can protect the load connected downstream of the switching device 1 from damage by interrupting the current paths by means of corresponding switching commands.

The control unit 2 can be parameterized in a wired or wireless manner. It is also possible for one or more parameters of the control unit 2 to be able to be set via a potentiometer of the control unit 2.

FIG. 3 shows, with a relatively low degree of detail, the schematic construction of a switching device 100 according to the invention which can be used in a circuit arrangement as illustrated in FIG. 1. Compared to the conventional switching device 1 shown in FIG. 2, the switching device 100 according to the invention is distinguished by the fact that a decentralized control unit 111, 211, 311 is assigned to each electronic interruption unit 11, 21, 31. In the illustrated configuration, the switching device 100 has, in addition to the decentralized control units 111, 211, 311, a central control unit 200 which performs coordination between the decentralized control units 111, 211, 311. Apart from the decentralized control units 111, 211, 311, the construction of the switching device 100 according to the invention illustrated in FIG. 3 is thus comparable to the construction of the conventional switching device 1 illustrated in FIG. 2; the circuit arrangement shown in FIG. 1 is just as possible with a switching device 100 according to the invention as with a conventional switching device 1.

The switching device 100 has three current paths 13, 23, 33, via which in each case one of the outer conductors L1, L2, L3 of the three-phase supply grid 50 can be routed. For this purpose, the switching device 1 has grid-side connection apparatuses 131, 231, 331, for example screw terminals or spring-loaded terminals, by means of which the grid-side ends of the current paths 13, 23, 33 can be electrically connected to connection lines 51 of the supply grid 50. For this purpose, the switching device 1 also has load-side connection apparatuses 132, 232, 332, for example screw terminals or spring-loaded terminals, by means of which the load-side ends of the current paths 13, 23, 33 can be electrically connected to connection lines 52 of the load 53.

An electronic interruption unit 11, 21, 31 and a mechanical switch 12, 22, 32 are respectively arranged in series in each of the current paths 13, 23, 33, wherein an electrical current having a current direction from the grid-side connection apparatuses 131, 231, 331 to the load-side connection apparatuses 132, 232, 332 flows first through the electronic interruption unit 11, 21, 31 and then through the mechanical switches 12, 22, 32. Current and/or voltage sensors 41, 42, 43, which are suitable for measuring the current I and/or the electrical voltage U in the current paths 13, 23, 33, are respectively arranged in the current paths 13, 23, 33 between the grid-side connection apparatuses 131, 231, 331 and the electronic interruption units 11, 21, 31.

Each of the electronic interruption units 11, 21, 31 is assigned in each case a decentralized control unit 111, 211, 311. These decentralized control units 111, 211, 311 receive measured values from the current and/or voltage sensors 41, 42, 43 via data lines 410, 420, 430 and send switching commands via communication connections 116, 216, 316 to the electronic interruption units 11, 21, 31. The measured values from the current and/or voltage sensors 41, 42, 43 can be present as analogue signals or as digital data. Data lines 410, 420, 430 are understood here as meaning any transmission means, both transmission lines, for example cables, wires, and wireless transmission means, for example NFC, Bluetooth, WLAN. The switching commands can be simple digital signals (with two different states: low-high).

The decentralized control units 111, 211, 311 can analyze the received measured values from the current and/or voltage sensors 41, 42, 43 and can determine on the basis of the analysis whether the current and/or voltage values lie in a customary and correct range or in an unacceptable range, for example in an overload range, a short-circuit range, etc. The decentralized control units 111, 211, 311 may each set a current-blocking state or a current-conducting state of the electronic interruption units 11, 21, 31 by means of corresponding switching commands. In regular operation, the decentralized control units 111, 211, 311 can switch a supply of electrical energy to the load by means of corresponding switching commands. For example, when interrupting a current path during regular operation, an undesired arc between the contacts of the mechanical switch can be avoided by first switching the electronic interruption unit 11, 21, 31 to a current-blocking state and only then opening the mechanical switch 12, 22, 32. If current and/or voltage values lie in an unacceptable range, the switching device 100 can protect the load connected downstream of the switching device 100 from damage by interrupting the current paths by means of corresponding switching commands.

The switching device 100 also has a central control unit 200 equipped with a processor 201. The central control unit 200 is connected to the decentralized control units 111, 211, 311 via communication connections 140, 240, 340; in this way, the central control unit 200 can coordinate the control behavior of the decentralized control units 111, 211, 311 by means of control commands.

The central control unit 200 communicates separately with each decentralized control unit 111, 211, 311. The communication serves, on the one hand, for information transmission and, on the other hand, for synchronization of all decentralized control units 111, 211, 311, so that, if required, coordinated switching of all electronic interruption units 11, 21, 31 is possible.

According to an alternative configuration, provision may also be made for the decentralized control units 111, 211, 311 to communicate directly with one another. For example, two digital signals (input and output) may be exchanged, i.e. sent and received, between the decentralized control units 111, 211, 311. For example, the information relating to a current zero crossing in a decentralized control unit can be transmitted to one or more of the other decentralized control units.

According to a first configuration outlined in FIG. 3, the mechanical switches 12, 22, 32 are driven by the central control unit 200 rather than by the decentralized control units 111, 211, 311. For this purpose, the central control unit 200 sends control commands via a control line 160 to a switching lock 150 acting on the mechanical switches 12, 22, 32.

According to an alternative configuration, the mechanical switches 12, 22, 32 are driven by the decentralized control units 111, 211, 311. In this case, the central control unit 200 sends switching commands, which are intended to switch the mechanical switches 12, 22, 32, to the decentralized control units 111, 211, 311 via communication connections 140, 240, 340. The decentralized control units 111, 211, 311 in turn send control commands to the switching lock 150 or directly to a switching actuator of the respective mechanical switch 12, 22, 32.

One variant of the switching device 100 is the relocation of one or more functions of the central control unit 200 into one of the decentralized control units 111, 211, 311. To this end, the functions can be integrated as software components in one of the decentralized control units 111, 211, 311. The coordination function may also be of decentralized design, for example integrated in one or more of the decentralized control units 111, 211, 311. The coordination function may be embodied as a software component, e.g. as firmware.

The control unit 2 can be parameterized in a wired or wireless manner.

FIG. 4 shows a configuration of a switching device 100 according to the invention with a relatively high degree of detail. The switching device 100 has three current paths 13, 23, 33, via which in each case one of the outer conductors L1, L2, L3 of a three-phase supply grid 50 can be routed. For this purpose, the switching device 100 has grid-side connection apparatuses 131, 231, 331, for example screw terminals or spring-loaded terminals, by means of which the grid-side ends of the current paths 130, 230, 330 can be electrically connected to connection lines 51 of the supply grid 50. For this purpose, the switching device 1 also has load-side connection apparatuses 132, 232, 332, for example screw terminals or spring-loaded terminals, by means of which the load-side ends of the current paths 13, 23, 33 can be electrically connected to connection lines 52 of the load 53.

A protection and measurement module 170, 270, 370 and a mechanical switch 12, 22, 32 are respectively arranged in series in each of the current paths 13, 23, 33, wherein an electrical current having a current direction from the grid-side connection apparatuses 131, 231, 331 to the load-side connection apparatuses 132, 232, 332 flows first through the protection and measurement modules 170, 270, 370 and then through the mechanical switches 12, 22, 32.

The protection and measurement modules 170, 270, 370 each have a grid-side connection apparatus 123, 223, 323 and a load-side connection apparatus 124, 224, 324, with which the protection and measurement modules 170, 270, 370 are connected into the current paths 13, 23, 33. The grid-side connection apparatuses 123, 223, 323 and the load-side connection apparatuses 132, 232, 332 are each electrically connected to one another by a load current line 130, 230, 330. The protection and measurement modules 170, 270, 370 each have a current sensor 114, 214, 314 for measuring the current I in the load current lines 130, 230, 330 and an electronic interruption unit 11, 21, 31, which are connected in series in the load current lines 130, 230, 330.

The protection and measurement modules 170, 270, 370 each have a decentralized control unit 111, 211, 311 which is assigned in each case to the electronic interruption unit 11, 21, 31 of the protection and measurement modules 170, 270, 370. These decentralized control units 111, 211, 311 receive measured values from the current sensors 114, 214, 314 via data lines 115, 215, 315 and send switching commands via communication connections 116, 216, 316 to the electronic interruption units 11, 21, 31. The decentralized control units 111, 211, 311 can analyze the received measured values from the current sensors 41, 42, 43 and can determine on the basis of the analysis whether the current values lie in a customary and correct range or in an unacceptable range, for example in an overload range, a short-circuit range, etc. The decentralized control units 111, 211, 311 may each set a current-blocking state or a current-conducting state of the electronic interruption units 11, 21, 31 by means of corresponding switching commands. In regular operation, the decentralized control units 111, 211, 311 can switch a supply of electrical energy to the load by means of corresponding switching commands. For example, when interrupting a load current line 130, 230, 330 during regular operation, an undesired arc between the contacts of the mechanical switch can be avoided by first switching the electronic interruption unit to a current-blocking state and only then opening the mechanical switch. If current and/or voltage values lie in an unacceptable range, the switching device 100 can protect the load connected downstream of the switching device 100 from damage by interrupting the current paths by means of corresponding switching commands.

The switching device 100 also has a central control unit 200 equipped with a processor 201. The central control unit 200 is connected to the protection and measurement modules 170, 270, 370 via communication connections 140, 240, 340. Here, the protection and measurement modules 170, 270, 370 each have an interface 112, 212, 312 which receives signals arriving from the central control unit 200 and sends signals from the protection and measurement modules 170, 270, 370 to the central control unit 200. For this purpose, the interfaces 112, 212, 312 are each connected to the corresponding decentralized control unit 111, 211, 311 via a communication connection 117, 217, 317. In this way, the central control unit 200 can coordinate the control behavior of the decentralized control units 111, 211, 311 by means of control commands; on the other hand, data and information required by the central control unit 200 for its coordination tasks can be transmitted from the protection and measurement modules 170, 270, 370 to the central control unit 200 in each case.

The central control unit 200 can also send control commands via a control line 160 to a switching lock 150 acting on the mechanical switches 12, 22, 32.

The control unit 2 can be parameterized in a wired or wireless manner.

FIG. 5 shows a flowchart of a short-circuit disconnection in a switching device according to the invention. A first step 501 marks a state in which current flows in a current path of the plurality of current paths of a switching device according to the invention, referred to below as “the current path”. In step 502, a current sensor determines measured values of the current intensity of the current flowing in the current path and sends the current measured values to the decentralized control unit assigned to it. In addition, a voltage sensor determines voltage measured values of the voltage applied to the current path and likewise sends the measured voltage measured values to the decentralized control unit assigned to it. In step 503, the decentralized control unit receives the measured current and voltage measured values from the sensors. In step 504, the decentralized control unit compares the current measured values with a permissible value range or a current limit value lₗᵢₘ. Here, two different cases are now considered: In a first case 1, the decentralized control unit determines in step 505 that the current measured values are within a permissible value range or below the current limit value lₗᵢₘ. Therefore, this measurement cycle is ended in step 506 with the result that no action is necessary and the next measurement cycle is awaited.

In a second case 2, the decentralized control unit determines in step 507 that the current measured values are above a permissible value range or above the current limit value lₗᵢₘ (trigger threshold). The decentralized control unit thus determines that a short circuit is present. In step 508, the decentralized control unit passes, without delay, a switch-off command directly to the electronic interruption unit, which is connected into the current path, so that the short circuit is terminated as quickly as possible. In step 509, the electronic interruption unit, triggered by the received switch-off command, changes to a current-blocking state. In step 510, the decentralized control unit reports, to the central control unit, the information that a short circuit has been detected in the current path and that a switch-off command has been sent to the electronic interruption unit connected into the current path. In step 511, the central control unit triggers actions of the other decentralized control units, e.g. a change of the electronic interruption units connected into the other current paths of the switching device into a current-blocking state. The central control unit thus coordinates the opening of the electronic interruption units in the other current paths 13, 23, 33 and preferably also the mechanical switches.

A similar method sequence can also be carried out when an imbalance is detected. In the case of a symmetrical load, the sum of the currents in the current paths (phases) is approximately equal to zero. When the imbalance is detected, the current intensities in all current paths are measured, summed and compared with a threshold value band: the sum of the measured values should lie in a value band of +−x amperes around the zero point. A typical value is x=2, wherein the value can be set at the switching device (parameterization). If the sum of the measured values lies within the threshold value band, no action is necessary. However, if the sum of the measured values lies outside the threshold value band, this is detected as an imbalance and a switch-off command is sent to the decentralized control units which then cause the electronic interruption units to be switched to a current-blocking state.

FIG. 6 illustrates an example of a short-circuit disconnection in a switching device according to the invention. The upper part of the graph shows a time profile of current intensity I_{sw} and grid voltage U_{GR} which are present in a current path of the plurality of current paths of the switching device, referred to below as “the current path”. The middle part of the graph shows a time profile of a gate signal S_{G} which is present at a gate of a gate-controlled semiconductor switch of the electronic interruption unit which is connected into the current path. The lower part of the graph shows a time profile of an output signal S_{c} from a current comparator which compares the current intensity I_{sw} present in the current path of the switching device with a current limit value lₗᵢₘ.

At a time t0 at which the sine curve of the grid voltage has a zero crossing and a voltage period begins, current flows through the current path of the switching device; this is made possible by virtue of the electronic interruption unit connected into the current path being in a current-conducting state, just like a mechanical switch which is connected in series with the electronic interruption unit, but is not considered further here. The electronic interruption unit has a semiconductor switch with a gate, for example a transistor or a thyristor; depending on the driving of the gate, the electronic interruption unit can be brought into a current-conducting or into a current-blocking operating state. At the time to, the electronic interruption unit is in a current-conducting state since a control signal S_{G}>0 is present at the gate.

At the time t1>t0, a short circuit is triggered in the current path (phase) under consideration. The current intensity I_{sw} then rises until a predefined current limit value lₗᵢₘ is exceeded at the time t2>t1. The exceeding of the current limit value lₗᵢₘ is detected by a comparator which continuously checks whether the current intensity I_{sw} exceeds the current limit value lₗᵢₘ; at the time t2 of the exceeding, the output signal S_{c} from the comparator changes from a value S_{c}=0 to a value S_{c}>0.

The decentralized control unit, which is assigned to the current path under consideration, passes, without delay, a switch-off command directly to the electronic interruption unit connected into the current path. Triggered by the switch-off command, the electronic interruption unit changes from the current-conducting state to a current-blocking state by virtue of the gate signal S_{G} changing from a value S_{G}>0 to a value S_{G}=0. As a result, the current in the current path decays to 0 A and the short circuit is extinguished.

FIG. 7 shows a flowchart of an operational switch-off in a switching device according to the invention. In step 701, the central control unit sends a switch-off command to the decentralized control units. In step 702, after receiving the switch-off command, the decentralized control units wait until the current is approximately 0 A with an adjustable hysteresis of +−0.5 A (parameterization). In step 703, the decentralized control units pass the switch-off command to the electronic interruption units. FIG. 8 shows a flowchart of a first mode of an operational switch-on in a switching device according to the invention. In the first step 801, the central control unit sends a switch-on command to the decentralized control units. In step 802, after receiving the switch-on command, the decentralized control units immediately send the switch-on command to the electronic interruption units.

FIG. 9 shows a flowchart of a an alternative mode of an operational switch-on in a switching device according to the invention. In the first step 811, the central control unit sends a voltage phase angle, at which a switch-on is intended to take place, to the decentralized control units. In step 812, the decentralized control unit evaluates the input voltage present at the input connections of the switching device and passes the switch-on command to the electronic interruption units when the voltage phase angle is reached.

FIG. 10 shows a further configuration of a switching device 100 according to the invention. The switching device has all features like the switching device shown in FIG. 4—the mechanical switches 12, 22, 32 are not shown in FIG. 10 in order to simplify the illustration—but additionally also has a bus-based communication system (for short: bus system) having a bus line 5 between the protection and measurement modules 170, 270, 370 which each have a decentralized control unit 111, 211, 311. The data communication via the bus system, for example using SPI or a serial interface such as UART, serves for exchanging information such as measurement variables and states of the decentralized control units 111, 211, 311 with one another in the form of binary character strings, without involving the central control unit 200. For example, this information exchange is necessary when implementing the central control functions in the decentralized control units 111, 211, 311 in the form of the FW block.

FIG. 11 shows a further configuration of a switching device 100 according to the invention. The switching device has all features like the switching device shown in FIG. 4—the mechanical switches 12, 22, 32 are not shown in FIG. 11 in order to simplify the illustration—but additionally also has a transmission system for transmitting digital signals via digital signal lines 6, 7, 8 between the protection and measurement modules 170, 270, 370 which each have a decentralized control unit 111, 211, 311. A first digital signal line 6 serves for transmitting signals from the decentralized control unit 111 of the first protection and measurement module 170 to the decentralized control units 211, 311 of the second and third protection and measurement modules 270, 370. A second digital signal line 7 serves for transmitting signals from the decentralized control unit 211 of the second protection and measurement module 270 to the decentralized control units 111, 311 of the first and third protection and measurement modules 170, 370. A third digital signal line 8 serves for transmitting signals from the decentralized control unit 311 of the third protection and measurement module to the decentralized control units 111, 211 of the first and second protection and measurement modules 170, 270.

Only digital individual signals with a rising edge, a falling edge and a duration of the signal level are transmitted as information carriers via the digital signal lines 6, 7, 8. In the case of these digital signals which are generated by the decentralized control units 111, 211, 311, information can be encoded in the rising edge, the falling edge and the duration of the signal level. Which information, for example overcurrent fault, overload fault, current zero crossing, is assigned to the respective signal can be stipulated in advance by the central control unit 200 in a coding rule which is made available to the decentralized control units 111, 211, 311. Zero current detection in one of the decentralized control units 111, 211, 311 could be mentioned here as an example. If a current zero crossing is detected by one of the decentralized control units 111, 211, 311, the detecting decentralized control unit 111, 211, 311 changes the level of a digital signal from low to high or from high to low. This signal level change is captured by the other decentralized control units 111, 211, 311 and actions can accordingly be triggered by the decentralized control units 111, 211, 311. The information relating to the zero crossing through a decentralized control unit 111, 211, 311 may be relevant to the other decentralized control units 111, 211, 311. The transmission system for transmitting digital signals via digital signal lines 6, 7, 8 between the decentralized control units 111, 211, 311 avoids delays which can occur in a bus system on the basis of the communication medium and the processing of the information.

1-12. (canceled)

13. A switching device, comprising:
at least two current paths used to supply energy for a downstream load;
an electronic interruption unit and a mechanical switch disposed in series in each of said current paths; and
decentralized controllers, each of said current paths is assigned one of said decentralized controllers configured to drive said electronic interruption unit.

14. The switching device according to claim 13, further comprising a central controller configured to communicate with said decentralized controllers for coordination of said electronic interruption unit and said mechanical switch in each of said at least two current paths.

15. The switching device according to claim 14, wherein said central controller is configured as a separate physical electronic component of the switching device or is integrated in a form of a firmware block in at least one said decentralized controller.

16. The switching device according to claim 13, further comprising sensors, each of said current paths is assigned one of said sensors for measuring a current intensity in respective current path of said current paths and/or a voltage in said respective current path against a reference voltage of another current path, wherein said sensors are configured such that measured values are transmitted to said decentralized controller assigned to said respective current path.

17. The switching device according to claim 13, wherein said decentralized controllers are configured to communicate directly with one another.

18. The switching device according to claim 13, wherein said decentralized controllers each have configurable analogue modules.

19. The switching device according to claim 16, wherein said decentralized controller, said electronic interruption unit and said sensor, which are each assigned to one of said current paths, form a module.

20. The switching device according to claim 14, wherein said central controller is configured to provide synchronization signals for said decentralized controllers.

21. A method for operating a switching device having at least two current paths used to supply energy for a downstream load, wherein an electronic interruption unit and a mechanical switch are disposed in series in each of the current paths, which method comprises the steps of:
driving the electronic interruption unit of a current path of the current paths in each case by means of a decentralized controller assigned to the current path.

22. The method according to claim 21, which further comprises sending, via a central controller of the switching device, synchronization signals to each said decentralized controller, by means of which the decentralized controllers can be synchronized.

23. The method according to claim 22, which further comprises:
measuring a current intensity and/or a voltage in the current path;
sending measured values to the decentralized controller assigned to the current path; and
sending control commands to the electronic interruption unit of the current path on a basis of the measured values measured in the current path.

24. The method according to claim 23, which further comprises:
sending information relating to the measured values and the control commands from the decentralized controllers to the central controller of the switching device; and
coordinating, by means of the central controller, the electronic interruption unit and the mechanical switch in each of the at least two current paths on a basis of the information received.
